(19) United States
(12) Patent Application Publication
(10) Pub. No.: US 2017/0299257 A1
(43) Pub. Date: Oct. 19, 2017

(54) Adjustable and Removable Door Lighting Assembly for a Refrigerator Appliance

(71) Applicant: General Electric Company, Schenectady, NY (US)

(72) Inventors: Louis A. Wantland, Louisville, KY (US); Bagawathkumar Chellappan, Louisville, KY (US)

(21) Appl. No.: 15/131,061

(22) Filed: Apr. 18, 2016

(51) Int. Cl. F25D 27/00; F25D 23/02; F25D 11/02; F21V 33/00; F25D 25/02; F21V 23/04; F21W 131/305

(52) U.S. Cl. CPC F25D 27/00; F25D 25/02; F25D 23/028; F21V 23/04; F25D 11/02; F21V 33/0044; F21W 2131/305

(57) ABSTRACT

An adjustable door lighting assembly for a refrigerator appliance is provided. In one embodiment, the refrigerator appliance can include a chilled chamber and a door rotatably hinged to the cabinet to provide selective access to the chilled chamber. The adjustable door lighting assembly can include a power track disposed on the door. The adjustable door lighting assembly can include at least one storage bin. The storage bin can include a light emitting device disposed on the storage bin The power track can be configured to deliver power to each respective light emitting device when the storage bin is engaged with the power track.

### FIELD OF THE INVENTION

The present subject matter relates generally to refrigerator appliances, and more particularly to adjustable and removable door lighting assemblies for refrigerator appliances.

### BACKGROUND OF THE INVENTION

Refrigerator appliances generally include a cabinet that defines a chilled chamber for receipt of food articles for storage. Refrigerator appliances can also include various storage components mounted within the chilled chamber and designed to facilitate storage of food items therein. Such storage components can include racks, bins, shelves, or drawers that receive food items and assist with organizing and arranging of such food items within the chilled chamber.

While food articles or other items stored in storage bins located on the door may be conveniently accessed, items placed in these storage bins may be difficult for a user to see due to insufficient lighting. For example, a light located on a back wall of the chilled chamber may not provide sufficient lighting for ease of viewing items located in storage bins mounted on the door. Moreover, a single light located on the door may not provide sufficient lighting for multiple storage bins. Therefore, a user may need to remove and/or rearrange items in a storage bin in order to locate a specific item. These difficulties can lead to consumer frustration and increased time when searching for items located in storage bins.

Accordingly, a refrigerator appliance with door mounted storage bins that provide light for easily identifying items located within the storage bins would be useful. More particularly, a refrigerator appliance with adjustable and or removable storage bins that provide light for easily identifying items located within the storage bins would be particularly beneficial.

### BRIEF DESCRIPTION OF THE INVENTION

Aspects and advantages of the invention will be set forth in part in the following description, or may be obvious from the description, or may be learned through practice of the invention.

One example aspect of the present disclosure is directed to a refrigerator appliance. The refrigerator includes a chilled chamber and a door rotatably hinged to the cabinet to provide selective access to the chilled chamber. The adjustable door lighting assembly includes a power track disposed on the door. The adjustable door lighting assembly also includes at least one storage bin. The storage bin includes a light emitting device on the storage bin. The power track is configured to deliver power to each light emitting device when the storage device is engaged with the power track.

Another example aspect of the present disclosure is directed to an adjustable door lighting assembly for a refrigerator appliance. The refrigerator appliance includes a cabinet defining a chilled chamber and a door rotatably hinged to the cabinet to provide selective access to the chilled chamber. The adjustable door lighting assembly includes a power track disposed on the door. The adjustable door lighting assembly further includes at least one storage bin. The storage bin includes a light emitting device disposed on the storage bin. The power track is configured to deliver power to each respective light emitting device when the storage bin is engaged with the power track.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a refrigerator appliance according to an exemplary embodiment of the present subject matter.

FIG. 2 provides a perspective view of the exemplary refrigerator appliance of FIG. 1 with refrigerator doors of the refrigerator appliance shown in an open position to reveal a fresh food chamber of the refrigerator appliance.

FIG. 3 provides a perspective view of an adjustable door lighting assembly located on the door of the exemplary refrigerator appliance of FIG. 1.

FIG. 4 provides a schematic circuit diagram of an adjustable door lighting assembly according to example aspects of the present disclosure.

FIG. 5 provides a schematic circuit diagram of an adjustable door lighting assembly according to example aspects of the present disclosure.

FIG. 6 provides a perspective view of a storage bin according to example aspects of the present disclosure.

FIG. 7 provides a side view of a storage bin with spring pin connectors according to example aspects of the present disclosure.

FIG. 8 provides a schematic view of overmolded contacts for use in an adjustable door lighting assembly according to example aspects of the present disclosure.

FIG. 9 provides a schematic view of an overmolded contact and mounting positions for use in an adjustable door lighting assembly according to example aspects of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Example aspects of the present disclosure are directed to an adjustable door lighting assembly for a refrigerator appliance. The adjustable door lighting assembly can include a plurality of storage bins that can be engaged with a power track. Each storage bin can include a light configured to provide light for ease of viewing items located in one or more storage bins in the adjustable door lighting assembly. Each storage bin can engage with the power track at multiple locations, allowing for the bins to be adjusted and/or removed from the adjustable door lighting assembly. When a storage bin is engaged with the power track, the power track can provide power to the light on a storage bin. However, when a storage bin is disengaged from the power track, the power track can continue to provide power to any other storage bins engaged with the power track.

In an embodiment, the power track can be a continuous power track wherein each storage bin is connected in parallel with any other engaged storage bins when the storage bins are engaged with the power track. In this way, the power track can provide continuous power to each storage bin irrespective of whether any other storage bins are engaged or disengaged from the power track.

In another embodiment, the power track can be a staggered track with two or more series connected terminal sections. Each terminal section can include a selective current limiting device, such as a zener diode. When a storage bin is engaged with a terminal section of the power track, the light of the storage bin can be connected in parallel with the selective current limiting device. When a storage bin is engaged with the power track, the selective current limiting device can block current through the selective current limiting device, thereby providing only a single current pathway through the light. When a storage bin is disengaged from the power track, the circuit is broken, and could cause the other storage bins to lose power. However, the selective current limiting device can then allow current to be conducted through the selective current limiting device, thereby completing the circuit and allowing power to be provided to each light on an engaged storage bin.

For example, the light on a storage bin can be a light emitting diode that operates at 3.3 volts. The selective current limiting device can be a zener diode with a 5 volt breakdown voltage. When the storage bin is engaged with the power track, the zener diode can block current through the zener diode, since the voltage across the diode will be less than the breakdown voltage of the zener diode. However, when the storage bin is disengaged, the current can flow through the zener diode, thereby completing the circuit and allowing power to be provided to any series connected storage bins. By connecting a plurality of zener diode/storage bin pairs in series, the power track can provide power to each power bin irrespective of whether another storage bin is removed. Moreover, by connecting the storage bins in series, a lower current can be used, reducing the potential for consumer exposure to a higher current.

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

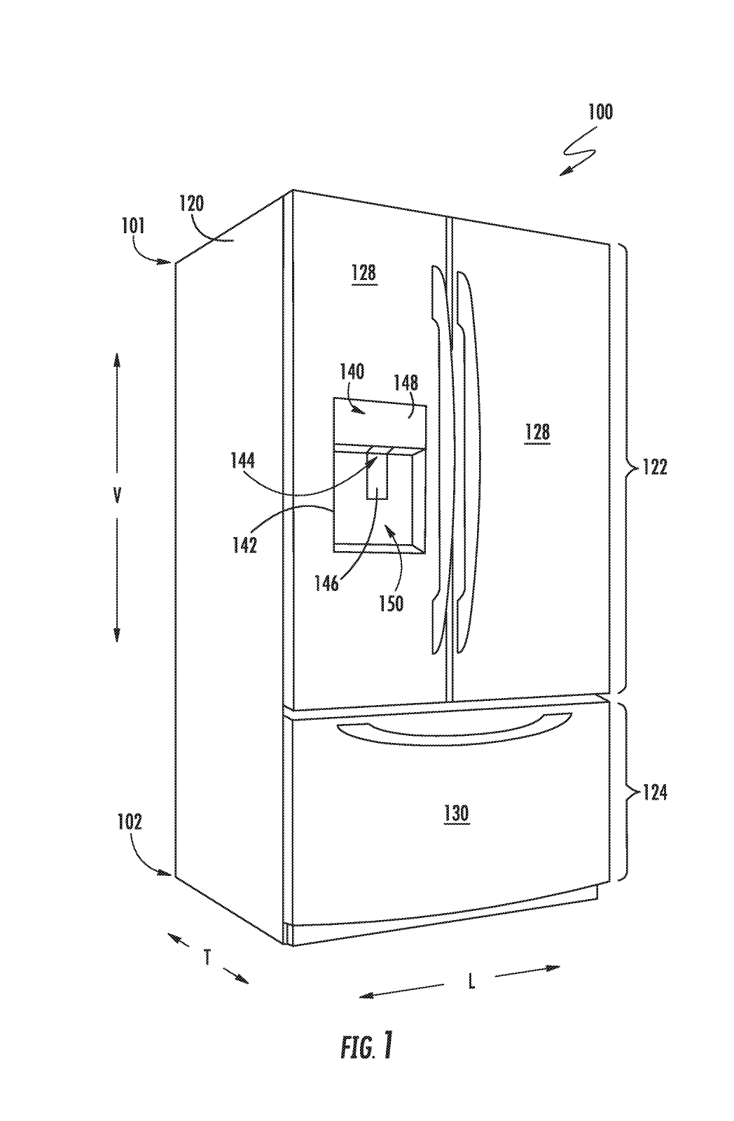

Referring now to the drawings, FIG. 1 provides a perspective view of a refrigerator appliance 100 according to an exemplary embodiment of the present subject matter. Refrigerator appliance 100 includes a cabinet or housing 120 that extends between a top 101 and a bottom 102 along a vertical direction V. Housing 120 also extends along a lateral direction L and a transverse direction T, each of the vertical direction V, lateral direction L, and transverse direction T being mutually perpendicular to one another. Housing 120 defines chilled chambers for receipt of food items for storage. In particular, housing 120 defines a fresh food chamber 122 positioned at or adjacent top 101 of housing 120 and a freezer chamber 124 arranged at or adjacent bottom 102 of housing 120. As such, refrigerator appliance 100 is generally referred to as a bottom mount refrigerator. It is recognized, however, that the benefits of the present disclosure apply to other types and styles of refrigerator appliances such as, e.g., a top mount refrigerator appliance or a side-by-side style refrigerator appliance. Consequently, the description set forth herein is for illustrative purposes only and is not intended to be limiting in any aspect to any particular refrigerator chamber configuration.

Refrigerator doors 128 are rotatably hinged to an edge of housing 120 for selectively accessing fresh food chamber 122. In addition, a freezer door 130 is arranged below refrigerator doors 128 for selectively accessing freezer chamber 124. Freezer door 130 is coupled to a freezer drawer (not shown) slidably mounted within freezer chamber 124. Refrigerator doors 128 and freezer door 130 are shown in the closed configuration in FIG. 1.

Refrigerator appliance 100 also includes a dispensing assembly 140 for dispensing liquid water and/or ice. Dispensing assembly 140 includes a dispenser 142 positioned on or mounted to an exterior portion of refrigerator appliance 100, e.g., on one of refrigerator doors 128. Dispenser 142 includes a discharging outlet 144 for accessing ice and liquid water. An actuating mechanism 146, shown as a paddle, is mounted below discharging outlet 144 for operating dispenser 142. In alternative exemplary embodiments, any suitable actuating mechanism may be used to operate dispenser 142. For example, dispenser 142 can include a sensor (such as an ultrasonic sensor) or a button rather than the paddle. A control panel 148 is provided for controlling the mode of operation. For example, control panel 148 includes a plurality of user inputs (not labeled), such as a water dispensing button and an ice-dispensing button, for selecting a desired mode of operation such as crushed or non-crushed ice.

Discharging outlet 144 and actuating mechanism 146 are an external part of dispenser 142 and are mounted in a dispenser recess 150. Dispenser recess 150 is positioned at a predetermined elevation convenient for a user to access ice or water and enabling the user to access ice without the need to bend-over and without the need to open refrigerator doors 128.

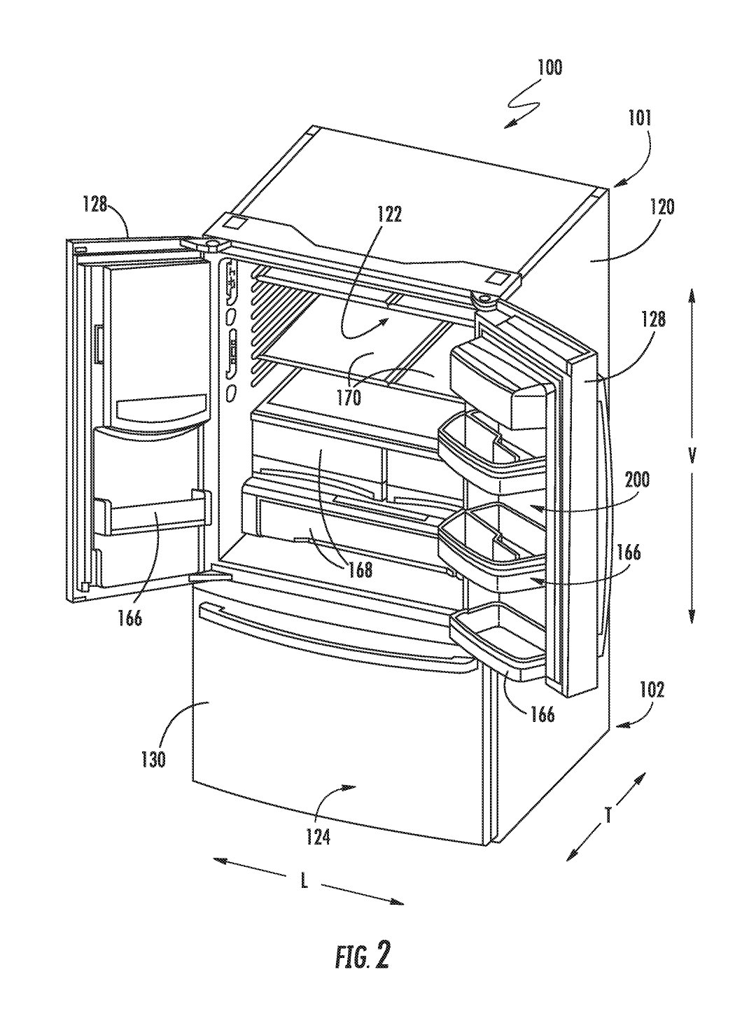

FIG. 2 provides a perspective view of a door of refrigerator appliance 100 shown with refrigerator doors 128 in the open position. According to the illustrated embodiment, various storage components are mounted within fresh food chamber 122 to facilitate storage of food items therein as will be understood by those skilled in the art. In particular, the storage components include storage bins 166, drawers 168, and shelves 170 that are mounted within fresh food chamber 122. Storage bins 166, drawers 168, and shelves 170 are configured for receipt of food items (e.g., beverages and/or solid food items) and may assist with organizing such food items. As an example, drawers 168 can receive fresh food items (e.g., vegetables, fruits, and/or cheeses) and increase the useful life of such fresh food items.

As will be discussed below, refrigerator appliance 100 may include an adjustable door lighting assembly 200 located on refrigerator door 128. Adjustable door lighting assembly 200 can include one or more storage bins 166 that include a light emitting device in order to provide light for ease of viewing items stored in storage bins 166.

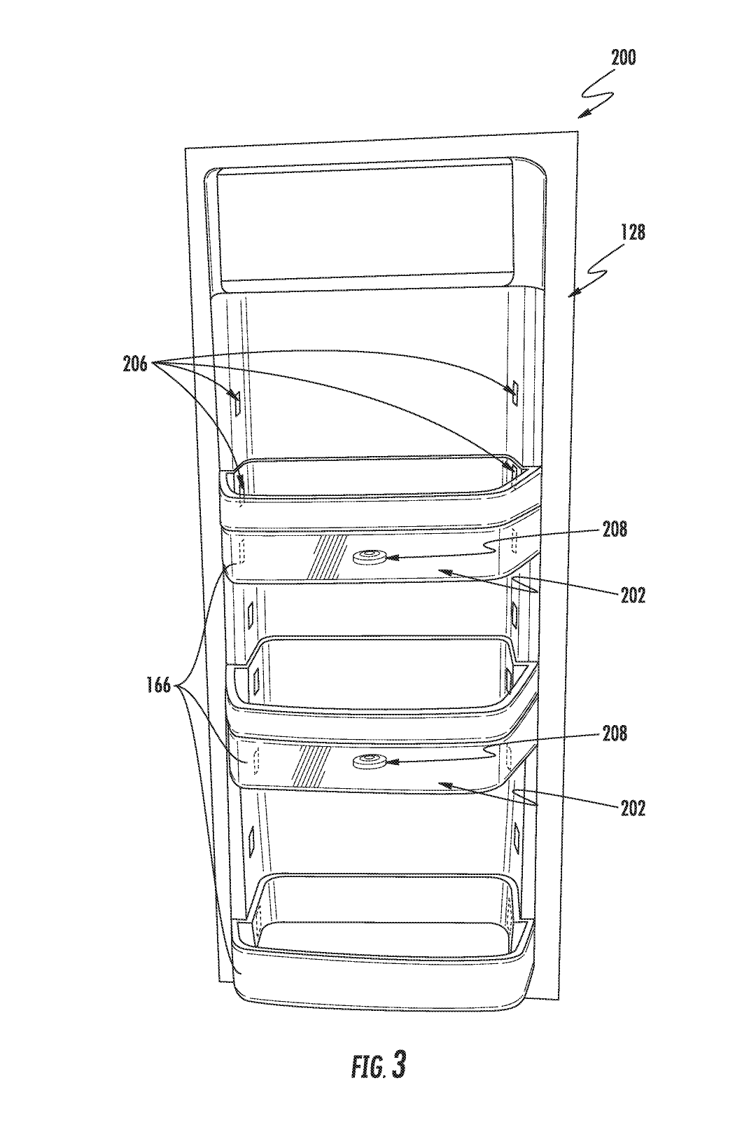

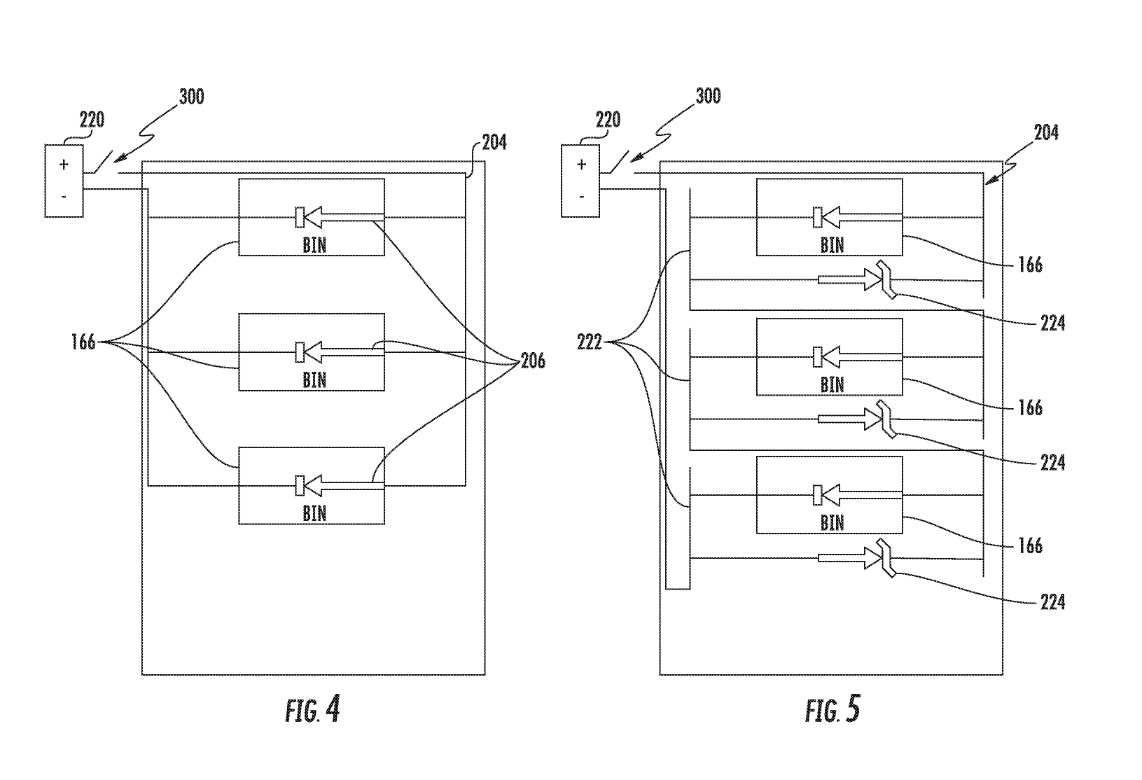

Referring now to FIG. 3, adjustable door lighting assembly 200 can generally include at least one storage bin 166. In an embodiment, adjustable door lighting assembly 200 can include a plurality of storage bins 166. For example, as depicted in FIG. 3, adjustable door lighting assembly 200 includes three storage bins 166. Those of ordinary skill in the art, using the disclosures provided herein, will understand that any number of storage bins 166 can be used without deviating from the scope of the present disclosure. Each storage bin 166 can include a light emitting device 202. For example, as depicted in FIG. 3, two storage bins 166 include a light emitting device 202, while one storage bin 166 does not. Each light emitting device 202 can provide light for viewing items stored in one or more storage bins 166. As will be discussed in greater detail with respect to FIGS. 4 and 5, a power track 204 (not shown) can be configured to deliver power to the light emitting device 202 of a storage bin 166 when the storage bin 166 is engaged with the power track 204. Additionally, when multiple storage bins 166 are engaged with power track 204, power track 204 can be configured to deliver power to each light emitting device 202 of each storage bin 166 engaged with the power track.

For example, each storage bin 166 can be configured to be mounted to refrigerator door 128 by one or more mounting devices 206 (as shown on FIG. 3, some of which are depicted in phantom). A plurality of mounting devices 206 can be included on refrigerator door 128 such that each storage bin 166 can be mounted to refrigerator door 128 in a plurality of mounting positions. For example, a refrigerator door 128 can define a top and a bottom. A storage bin 166 could be mounted in a first position in the adjustable door lighting assembly 200 towards the top of refrigerator door 128, or mounted in a second position in the adjustable door lighting assembly 200 towards the bottom of refrigerator door 128. A storage bin 166 can also be mounted in any number of other mounting positions. In this way, each storage bin 166 can be adjustable within the adjustable door lighting assembly 200. Each storage bin 166 can further be configured to engage with the power track 204 irrespective of whether the storage bin 166 is in the first position, the second position, or any other mounting position. As depicted in FIG. 3, adjustable door lighting assembly 200 can also include a top light emitting device 208 configured to provide light to one or more storage bins 166.

Referring now to FIG. 4, a circuit diagram for a configuration of a power track 204 according to example aspects of the present disclosure is provided. Power track 204 can be disposed on a door, such as on an inside surface of a refrigerator door 128. As shown, power track 204 can include a power supply 220 configured to provide power to power track 204 and any light emitting devices 202 electrically connected to power track 204. Power track 204 can be configured to provide power to each storage bin engaged with the power track. For example, as shown in FIG. 4, power track 204 can be a continuous track where a plurality of storage bins 166 can be electrically connected in parallel. When a storage bin 166 is engaged with power track 204, power from power supply 220 can flow through the light emitting device 202 of a storage bin 166 to provide light for viewing items stored in one or more storage bins 166 engaged with the power track 204. In an embodiment, power track 204 can be configured to allow a storage bin 166 to be engaged with the power track 204 in a plurality of locations. For example, an adjustable door lighting assembly 200 can have a plurality of mounting positions, wherein each mounting position is configured to engage a storage bin 166 with the power track 204. In an embodiment, power track 204 can be configured to provide power to each storage bin engaged with the power track 204 when the refrigerator door 128 is in the open position. For example, a switch, such as switch 300 shown in FIG. 4, can be configured to close when the door is in the open position, thereby connecting power track 204 to power supply 220.

As shown in FIG. 4, 3 storage bins 166 are connected in parallel to a continuous power track 204. As each storage bin 166 is engaged with the power track 204, the light emitting device 202 of each storage bin 166 can be electrically connected to the power track 204 in parallel with the light emitting device of any other storage bins 166 engaged with power track 204. In this way, each light emitting device 202 can be engaged or disengaged from power track 204 without interrupting the supply of power to any other light emitting devices 202 electrically connected to power track 204. Further, in this way, power track 204 can be configured to provide power to each storage bin engaged with the power track irrespective of whether any other storage bin is disengaged from the power track. Thus, a power track 204 as shown in FIG. 4 can be used to allow storage bins 166 to be removed from the adjustable door lighting assembly 200 without interrupting the supply of power to any other storage bins 166 engaged with the adjustable door lighting assembly 200.

Referring now to FIG. 5, a circuit diagram for a power track 204 according to example aspects of the present disclosure is provided. Power track 204 can be disposed on a door, such as on an inside surface of a refrigerator door 128. As shown, power track 204 can include a power supply 220 configured to provide power to power track 204 and any light emitting devices 202 electrically connected to power track 204. Power track 204 can be configured to provide power to each storage bin engaged with the power track. For example, as shown in FIG. 4, power track 204 can be a staggered track comprising a plurality of terminal sections 222 connected in series. For example, as shown in FIG. 5, three terminal sections 222 are connected in series. Each terminal section 222 can be configured to receive a storage bin 166. In an embodiment, each terminal section 222 can be configured to allow a storage bin 166 to be engaged with the terminal section 222 in a plurality of locations. For example, an adjustable door lighting assembly 200 can have a plurality of mounting positions, wherein each mounting position is configured to engage a storage bin 166 with a terminal section 222 such that the light emitting device 202 is electrically connected in parallel with the selective current limiting device 224 when the storage bin 166 is engaged with the power track in any of the mounting positions.

A first terminal section can be connected to a first terminal of the power source 220 and a last terminal section can be connected to a second terminal of the power source 220. When the power source 220 is turned on, power can flow through each series-connected terminal section 222. When a storage bin 166 is engaged with power track 204, power from power supply 220 can flow through the light emitting device 202 of a storage bin 166 to provide light for viewing items stored in one or more storage bins 166 engaged with the power track 204. In an embodiment, power track 204 can be configured to provide power to each storage bin engaged with the power track 204 when the refrigerator door 128 is in the open position. For example, a switch, such as switch 300 shown in FIG. 5, can be configured to close when the door is in the open position, thereby connecting power track 204 to power supply 220.

As shown in FIG. 5, each terminal section 222 can include a selective current limiting device 224 electrically connected to each terminal section 222. Each selective current limiting device 224 can either selectively block or allow a current to flow through the selective current limiting device 224. Each terminal section 222 can be configured such that when a storage bin 166 is engaged with the power track 204, the light emitting device 202 of the storage bin 166 is connected in parallel with the selective current limiting device 224. Each terminal section 222 can be configured such that when a storage bin 166 is engaged with the power track 204, the selective current limiting device 224 of the power track 204 can block an electrical current through the selective current limiting device 224, providing a single pathway for an electrical current to flow, namely through the light emitting device 202 before continuing to any series connected terminal sections 222. When a storage bin 166 is disengaged from a terminal section 222, the selective current limiting device 224 can be configured such that an electrical current can flow through the current limiting device 224 before continuing to any series connected terminal sections 222.

For example, in an embodiment, a selective current limiting device 224 can be a zener diode that has a breakdown voltage greater than the voltage of a light emitting device 202. For example, a light emitting device 202 can be a light emitting diode with an operational voltage of about 3.3 volts, and a selective current limiting device 224 can be a zener diode with a breakdown voltage of about 5 volts. As used herein, the term “about” when used in connection with a numerical value is intended to refer to within 20% of the stated numerical value. Other combinations of light emitting devices and selective current limiting devices can be used without departing from the spirit or scope of the current disclosure. When the light emitting device 202 is connected in parallel with a zener diode of a terminal section 222, the voltage across the zener diode will be less than the break down voltage, and the zener diode will not allow an electrical current to flow through the zener diode. Accordingly, an electrical current will only have a single pathway to flow, namely through the light emitting device 202 before continuing to any series connected terminal sections 222. However, when a storage bin 166 is disengaged from a terminal section 222, the current path through the light emitting device 202 will be broken. The zener diode can then become reverse-biased, and if the voltage across the zener diode exceeds the breakdown voltage of the zener diode, an electrical current will be allowed to flow through the zener diode before continuing onto any series connected terminal sections 222.

In this way, each light emitting device 202 can be engaged or disengaged from power track 204 without interrupting the supply of power to any other light emitting devices 202 electrically connected to power track 204. Further, in this way, power track 204 can be configured to provide power to each storage bin engaged with the power track irrespective of whether any other storage bin is disengaged from the power track. Thus, a power track 204 as shown in FIG. 5 can be used to allow storage bins 166 to be removed from the adjustable door lighting assembly 200 without interrupting the supply of power to any other storage bins 166 in the adjustable door lighting assembly 200.

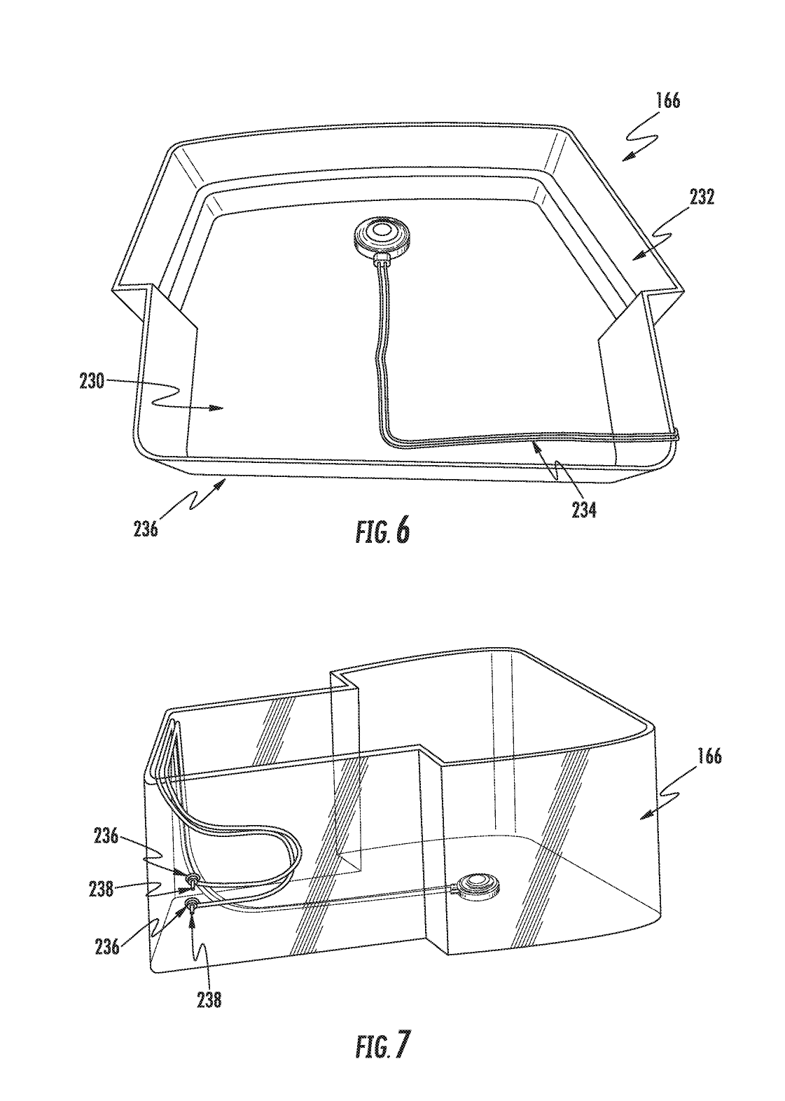

Referring now to FIG. 6, a storage bin 166 according to example aspects of the present disclosure is shown. Each storage bin 166 can be configured for receipt of food items (e.g., beverages and/or solid food items) and may assist with organizing such food items. For example, each storage bin 166 can include a bottom surface 230 and one or more walls 232 for receiving and storing food items. A storage bin 166 can also include an underside 236 located on the bottom of the storage bin 166. Storage bin 166 can be mounted within a fresh food chamber, such as fresh food chamber 122 shown in FIG. 2, to facilitate storage of food items therein as will be understood by those skilled in the art. In particular, one or more storage bins 166 can be mounted on an adjustable door lighting assembly 200 located on a refrigerator door 128. Each storage bin 166 can be configured to engage with one or more mounting devices 206 for the purpose of mounting the storage bin 166 to an adjustable door lighting assembly 200. For example, an adjustable door lighting assembly 200 can include a plurality of mounting devices 206 comprising a plurality of matched pairs of nubbins, wherein each matched pair of nubbins is configured to receive and support a storage bin 166, as shown in FIG. 3. Each matched pair of nubbins can be located on an adjustable door lighting assembly 200 at a consistent distance apart from each other such that a storage bin 166 can be mounted on any matched pair of nubbins within the adjustable door lighting assembly 200. In this way, a storage bin 166 can be adjustable within an adjustable door lighting assembly 200.

As shown in FIG. 6, storage bin 166 can include a light emitting device 202. In an embodiment, light emitting device 202 can be a light emitting diode. In another embodiment, a light emitting device 202 can be a light emitting diode operated at a voltage of about 3.3 volts. Other light emitting devices can be used without departing from the spirit or scope of the present disclosure. In an embodiment, the light emitting device 202 may be located on the underside 236 of a storage bin 166. For example, a light emitting device 202, such as a light emitting diode, can be located on the underside 236 of a first storage bin 166 as shown in FIG. 6 for the purpose of providing light to a second storage bin 166 mounted at a position below the first storage bin. In another embodiment not depicted in FIG. 6, a light emitting device 202 can be configured within a storage bin 166 such that the light emitting device 202 can provide light for viewing any items stored in the storage bin 166.

A storage bin 166 can also include one or more conductors 234 for delivering electrical power to the light emitting device 202 when a storage bin 166 is engaged with an adjustable door lighting assembly 200. The one or more conductors 234 can be configured to make an electrical connection with a power track 204, such as a continuous or staggered power track as depicted in FIGS. 4 and 5. In one or more embodiments, the one or more conductors 234 can be located on the underside of the storage bin 166, located on the bottom surface of the storage bin 166, or can be integrated into the storage bin 166, such as in a channel molded in the storage bin 166.

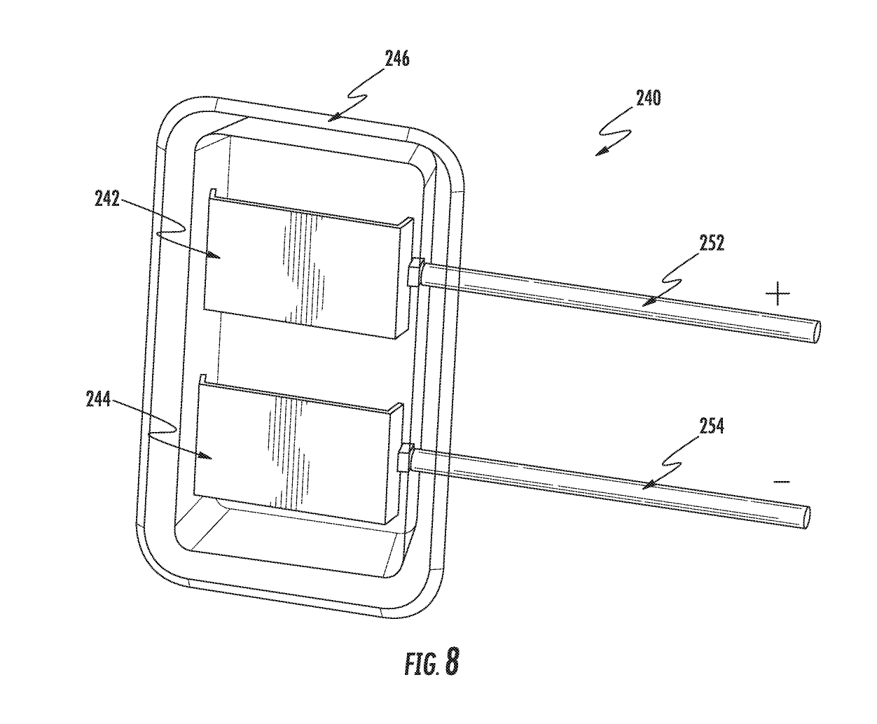

Referring now to FIG. 7, a side view of a storage bin 166 according to example aspects of the present disclosure is shown. As shown in FIG. 7, a storage bin 166 can include one or more spring pin connectors 236 configured to make an electrical connection with a power track 204 when the storage bin 166 is engaged with the power track 204. Other types of electrical connectors can be used to connect a storage bin 166 to a power track 204 as well. As depicted in FIG. 7, a pair of spring pin connectors 236 can be mounted on a side 232 of a storage bin 166. In another embodiment, the spring pin connectors 236 can be located in any alternate location on the storage bin 166.

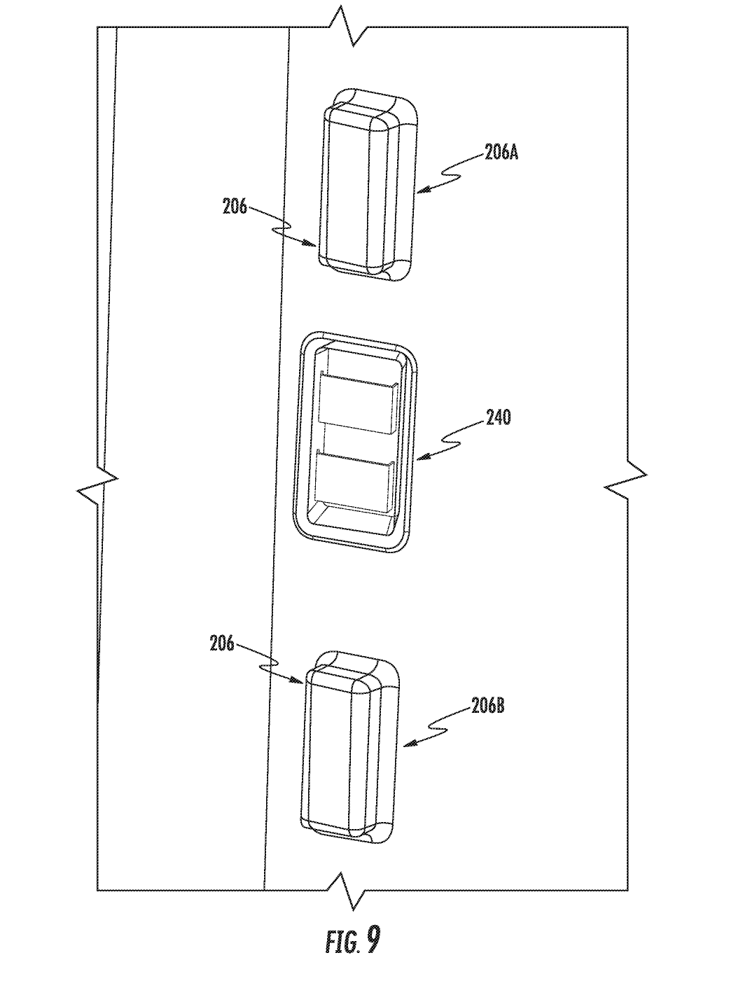

Each spring pin connector 236 can include a spring (not depicted) configured to depress a contactor 238 such that the contactor 238 can make an electrical connection with a power track 204. For example, in an embodiment, two spring pin connectors 236 mounted on the side of a storage bin 166 can be configured to make an electrical connection with an overmolded contact 240 depicted in FIG. 8. In this way, a storage bin 166 can be engaged with a power track 204 when the storage bin 166 is mounted in an adjustable door lighting assembly 200.

Referring now to FIG. 8, an overmolded contact 240 according to example aspects of the present disclosure is shown. Other types of contactors can be used to connect a storage bin 166 to a power track 204 as well. As shown in FIG. 8, an overmolded contact 240 can include a first contact plate 242 and a second contact plate 244 located within a housing 246. The housing 246 can act as an insulator for the first contact plate 242 and second contact plate 244, and can be integrated into an inside cover for a door 128. The first contact plate 242 and the second contact plate 244 can be made out of any suitable metal, such as stainless steel, and can be manufactured using any known metal manufacturing technique, such as metal stamping. The first contact plate 242 and the second contact plate 244 can be connected to a first conductor 252 and second conductor 254, respectively. The first conductor 252 and second conductor 254 can be connected to a power track 204. For example, a first conductor 252 can be connected to a first side of a continuous track and a second conductor 254 can be connected to a second side of a continuous track such that a storage bin 166 connected to an overmolded contact 240 is electrically connected in parallel with any other storage bins 166 connected to the power track 204. In another embodiment, a first conductor 252 can be connected to a first side in a terminal section 222 of a staggered power track and a second conductor 254 can be connected to a second side in the terminal section 222 such that any storage bin 166 connected to the overmolded contact 240 is electrically connected in parallel with the selective current limiting device 224 of the terminal section 222.

Referring now to FIG. 9, a perspective view of an example contactor and mounting configuration is shown. As shown in FIG. 9, an overmolded contact 240 is located between a pair of mounting devices 206. For example, as shown, the mounting devices 206 are arranged in a vertical orientation with respect to each other, designated a top mounting device 206A and a bottom mounting device 206B. In an embodiment, each mounting device 206 is one half of a pair of matched nubbins configured to receive a storage bin 166. As shown, the overmolded contact 240 is located between the two mounting devices 206 such that when a storage bin 166 is engaged with the top mounting device 206A, the storage bin 166 makes an electrical connection with the overmolded contact 240. Other types of contactors can be used without departing from the spirit or scope of the present disclosure.

In an embodiment, each mounting device 206 can have an associated overmolded contact 240 configured to make an electrical connection with a storage bin 166, thereby engaging the storage bin 166 with a power track 204, when the storage bin 166 is mounted on the mounting device 206. In this way, an adjustable door lighting assembly 200 can include a plurality mounting positions for a storage bin 166, wherein each mounting position is configured to engage the storage bin 166 with a power track 204.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance comprising:
a cabinet defining a chilled chamber;
a door being rotatably hinged to the cabinet to provide selective access to the chilled chamber;
at least one storage bin, the storage bin comprising a light emitting device disposed on the storage bin; and
a power track disposed on the door,
wherein the power track is configured to deliver power to each respective light emitting device when the storage bin is engaged with the power track.

2. The refrigerator appliance of claim 1, wherein the refrigerator appliance comprises a plurality of storage bins.

3. The refrigerator appliance of claim 2, wherein the power track is configured to provide power to each storage bin engaged with the power track irrespective of whether any other storage bin is disengaged from the power track.

4. The refrigerator appliance of claim 3, wherein the power track is a continuous track, wherein the storage bins are electrically connected in parallel to the continuous track.

5. The refrigerator appliance of claim 3, wherein the power track comprises a staggered track comprising a plurality of terminal sections coupled in series, each terminal section having a selective current limiting device, wherein the light emitting device of a storage bin is electrically connected in parallel with the selective current limiting device of a terminal section when the storage bin is engaged with the power track.

6. The refrigerator appliance of claim 5, wherein each terminal section is configured to conduct a current through the selective current limiting device when a storage bin is not engaged with the terminal section.

7. The refrigerator appliance of claim 5, wherein the selective current limiting device comprises a zener diode.

8. The refrigerator appliance of claim 7, wherein the zener diode is operated at a voltage greater than the voltage of the light emitting device.

9. The refrigerator appliance of claim 7, wherein the zener diode has a breakdown voltage of approximately 5 volts.

10. The refrigerator appliance of claim 1, wherein the light emitting device comprises a light emitting diode.

11. The refrigerator appliance of claim 10, wherein the light emitting diode is operated at a voltage of approximately 3.3 volts.

12. The refrigerator appliance of claim 1, wherein the storage bin defines an underside, wherein the light emitting device is disposed on the underside of the storage bin.

13. The refrigerator appliance of claim 1, wherein the at least one storage bin is configured to engage with the power track at a plurality of mounting positions.

14. The refrigerator appliance of claim 1, wherein the power track comprises an overmolded contact configured to provide power to a storage bin when the storage bin is engaged with the power track.

15. The refrigerator appliance of claim 14, wherein the overmolded contact is located between at least two mounting positions.

16. The refrigerator appliance of claim 14, wherein the storage bin comprises one or more spring pin connectors configured to electrically connect the storage bin to the overmolded contact.

17. The refrigerator appliance of claim 1, wherein the door defines an open position, wherein the power track is configured to provide power to the at least one storage bin when the door is in the open position.

18. An adjustable door lighting assembly for a refrigerator appliance, the refrigerator appliance comprising a cabinet defining a chilled chamber and a door rotatably hinged to the cabinet to provide selective access to the chilled chamber, the adjustable door lighting assembly comprising:
a power track disposed on the door, and
at least one storage bin, the storage bin comprising a light emitting device disposed on the storage bin,
wherein the power track is configured to deliver power to each respective light emitting device when the storage bin is engaged with the power track.

19. The adjustable door lighting assembly of claim 18, wherein the power track comprises a staggered track comprising a plurality of terminal sections coupled in series, each terminal section having a selective current limiting device, wherein the light emitting device of a storage bin is electrically connected in parallel with the selective current limiting device of a terminal section when the storage bin is engaged with the power track.

20. The adjustable door lighting assembly of claim 19, wherein each terminal section is configured to conduct a current through the selective current limiting device when a storage bin is not engaged with the power track.
